(19) United States
(12) Patent Application Publication
(10) Pub. No.: US 2025/0282662 A1
(43) Pub. Date: Sep. 11, 2025

(54) WASTEWATER TREATMENT SYSTEM AND WASTEWATER TREATMENT METHOD USING THE SAME

(71) Applicant: Samsung Electronics Co., Ltd., Suwon-si (KR)

(72) Inventors: CHANGHYUN NAHM, Suwon-si (KR); GEUNHYUCK CHOI, Suwon-si (KR); JongYeop Lee, Suwon-si (KR); GUNHEE KIM, Suwon-si (KR); GWANGHA LEE, Suwon-si (KR)

(21) Appl. No.: 19/216,014

(22) Filed: May 22, 2025

Related U.S. Application Data
(63) Continuation of application No. PCT/CN2023/135195, filed on Nov. 29, 2023.

(30) Foreign Application Priority Data
Nov. 6, 2024 (KR) 10-2024-0156452

(51) Int. Cl. C02F 3/30; C02F 3/00; C02F 3/12; C02F 101/16; C02F 103/00

(52) U.S. Cl. CPC C02F 3/305; C02F 3/006; C02F 3/121; C02F 2003/003; C02F 2101/163; C02F 2103/005; C02F 2209/005; C02F 2209/14; C02F 2209/15

(57) ABSTRACT

A wastewater treatment system including an organic water-collection tank configured to receive and store wastewater as raw water, a first denitrification tank configured to convert the raw water into primary treated water a nitrification tank configured to convert the primary treated water into secondary treated water, a second denitrification tank configured to receive an organic carbon source from a carbon supply unit and to convert the secondary treated water into tertiary treated water, a re-aeration tank configured to convert the tertiary treated water into a quaternary treated water, a sedimentation tank configured to separate the quaternary treated water into sludge and supernatant, a wastewater analysis unit configured to analyze information from the wastewater, and a control unit configured to calculate and control a supply amount of the organic carbon source using the wastewater information.

### CROSS-REFERENCE TO RELATED APPLICATION

This application claims priority to and the benefit of Korean Patent Application No. 10-2024-0156452 filed in the Korean Intellectual Property Office on Nov. 6, 2024, the entire contents of which is incorporated herein by reference.

### BACKGROUND OF THE INVENTION

### (a) Field of the Invention

The present disclosure relates to a wastewater treatment system and a wastewater treatment method using the same.

### (b) Description of the Related Art

If wastewater is discharged into a river without removing the nitrogen components in the wastewater, a state of excessive nutrient salts, i.e. eutrophication, occurs. For example, when present, such as phosphate (PO₄³⁻), it can be assimilated into substances within cells and cause mass growth of algae, and when going through the nitrification process, it can consume a large amount of oxygen and cause an oxygen shortage. In particular, ammonia among nitrogen compounds is toxic to aquatic organisms when it exceeds a certain amount, and nitrate ions (NO₃⁻) can generate carcinogens when combined with other substances. Accordingly, water quality is managed by setting standards for nitrogen.

As a method of nitrogen treatment in wastewater, a biological wastewater treatment method utilizing microorganisms is being used. This includes a process of converting ammonia nitrogen (NH₃—N) into nitrate nitrogen (NO₃—N) through an organic process. In particular, in the case of semiconductor wastewater, the ammonia nitrogen (NH₃—N) concentration is high and the carbon concentration is low due to the process characteristics, and taking this into consideration, an organic carbon source is added from outside to control the nitrogen concentration.

Typically, the organic carbon source is input into a post-denitrification tank located on a downstream side of a nitrification tank. The input amount of the organic carbon source is adjusted by a feed-back method, in which it is controlled according to the nitrate nitrogen (NO₃—N) concentration in the re-aeration tank after the post-denitrification tank. However, in the above-described feed-back method, manual operations are performed in reality by more than a certain number of times due to various variables, and there is a problem that the number of quality deviations increases due to these manual operations.

To address the above-described problem, it is important to develop an automatic control system to control the input amount of organic carbon source by reflecting various variables in real time.

### SUMMARY OF THE INVENTION

The present disclosure provides a wastewater treatment system and a wastewater treatment method using the same capable of minimizing manual manipulations during the course of controlling the input amount of the organic carbon source, by calculating a suitable amount of an organic carbon source to be supplied, in consideration of various variables that occur before inputting the organic carbon source, by using a feed-forward method utilizing a NH₃ concentration of raw water in an organic water-collection tank, a NO₃ concentration in a first denitrification tank, and a NH₃ concentration in a nitrification tank.

In particular, the present disclosure provides a wastewater treatment system and a wastewater treatment method using the same, capable of accurately analyzing the NH₃ concentration in real-time without requiring maintenance in comparison with an organic water-collection tank NH₃ analysis unit because the NH₃ concentration of raw water in an organic water-collection tank is not obtained by a measurement system installed in the organic water-collection tank but calculated by analyzing in real time the wastewater supplied to the organic water-collection tank based on an amount input from a central chemical supply system (CCSS) to a semiconductor process.

In addition, provided are a wastewater treatment system and a wastewater treatment method using the same, that are capable of, when a change occurs in the wastewater before being transferred to the organic water-collection tank, automatically adjusting the input amount of the organic carbon source, by reflecting various variables occurring in the wastewater by immediately reflecting the above-described change to the NH₃ concentration of the raw water.

A wastewater treatment system may include an organic water-collection tank configured to receive wastewater discharged from a wastewater supply device and to store the received wastewater as raw water, a first denitrification tank configured to receive the raw water from the organic water-collection tank and to convert the raw water into primary treated water by reducing nitrate nitrogen contained in the raw water into nitrogen gas, a nitrification tank configured to receive the primary treated water from the first denitrification tank and to convert the primary treated water into secondary treated water by oxidizing ammonia nitrogen in the primary treated water, a carbon supply unit, a second denitrification tank configured to receive the secondary treated water from the nitrification tank and to receive an organic carbon source from the carbon supply unit to remove residual nitrate nitrogen from the secondary treated water to convert the secondary treated water into tertiary treated water, a re-aeration tank configured to receive the tertiary treated water from the second denitrification tank and to convert the tertiary treated water into quaternary treated water by removing nitrogen gas from the tertiary treated water and oxidizing residual ammonia nitrogen in the tertiary treated water into nitrate nitrogen, a sedimentation tank configured to receive quaternary treated water from the re-aeration tank and to separate the quaternary treated water into sludge and supernatant, a wastewater analysis unit configured to analyze information from the wastewater discharged from the waste water supply device, and a control unit configured to calculate a supply amount of the organic carbon source to be supplied from the carbon supply unit to the second denitrification tank, using information from the wastewater analyzed by the wastewater analysis unit, and configured to control supply of the supply amount of the organic carbon source from the carbon supply unit to the second denitrification tank.

A wastewater treatment system may include a wastewater analysis unit configured to analyze information from wastewater discharged from a wastewater supply device, an organic water-collection tank configured to receive the wastewater and store the received wastewater as raw water, a first denitrification tank configured to receive the raw water from the organic water-collection tank, and to convert the raw water into primary treated water by reducing nitrate nitrogen contained in the raw water into nitrogen gas, a first analyzer configured to analyze a first NO₃ concentration in the primary treated water, a nitrification tank configured to receive the primary treated water from the first denitrification tank and to convert the primary treated water into secondary treated water by oxidizing ammonia nitrogen in the primary treated water, a second analyzer configured to analyze a second NH₃ concentration in the secondary treated water, a carbon supply unit, a second denitrification tank configured to receive the secondary treated water from the nitrification tank, and to receive an organic carbon source from the carbon supply unit, to remove residual nitrate nitrogen from the secondary treated water to convert the secondary treated water into tertiary treated water,, a re-aeration tank configured to receive the tertiary treated water from the second denitrification tank and to convert the tertiary treated water into quaternary treated water by removing nitrogen gas from the tertiary treated water, and oxidizing residual ammonia nitrogen in the tertiary treated water into nitrate nitrogen, a third analyzer configured to analyze a third NO₃ concentration in the quaternary treated water, a sedimentation tank configured to receive the quaternary treated water from the re-aeration tank to separate the quaternary treated water into sludge and supernatant, and a control unit configured to calculate a supply amount of the organic carbon source to be supplied from the carbon supply unit to the second denitrification tank, and configured to control a supply amount of the organic carbon source from the carbon supply unit to the second denitrification tank.

A wastewater treatment method may include analyzing information from wastewater discharged from a wastewater supply device, receiving, by an organic water-collection tank, the wastewater and storing the wastewater as raw water, receiving, by a first denitrification tank, the raw water from the organic water-collection tank and converting the raw water into a primary treated water by reducing nitrate nitrogen contained in the raw water into nitrogen gas, receiving, by a nitrification tank, the primary treated water from the first denitrification tank, and converting the primary treated water into a secondary treated water by oxidizing ammonia nitrogen in the primary treated water, receiving, by a second denitrification tank, the secondary treated water from the nitrification tank, and converting the secondary treated water into a tertiary treated water by removing residual nitrate nitrogen from the secondary treated water by using an organic carbon source, receiving, by a re-aeration tank, the tertiary treated water from the second denitrification tank, removing nitrogen gas in the tertiary treated water, and converting the tertiary treated water into a quaternary treated water by oxidizing residual ammonia nitrogen into nitrate nitrogen, receiving, by a sedimentation tank, the quaternary treated water from the re-aeration tank and separating the quaternary treated water into sludge and supernatant; and controlling a supply amount of the organic carbon source, to supply the organic carbon source to the second denitrification tank.

According to an embodiment, the wastewater treatment process may be automated by minimizing manual operations during the course of controlling the input amount of the organic carbon source, by controlling the input amount of the organic carbon source in a feed-forward method by using the same while reflecting changes in wastewater in real time.

### BRIEF DESCRIPTION OF THE DRAWINGS

FIG. 1 is a drawing showing a conventional wastewater treatment system.

FIG. 2 is a drawing showing wastewater treatment systems according to example embodiments.

FIG. 3 depicts a configuration of wastewater treatment systems according to example embodiments.

FIG. 4 to FIG. 8 are flowcharts showing wastewater treatment methods according to example embodiments.

FIG. 9 to FIG. 13B are graphs depicting effects of a wastewater treatment system according to example embodiments.

### DETAILED DESCRIPTION OF THE EMBODIMENTS

Hereinafter, the present disclosure will be described in detail with reference to the accompanying drawings, in which embodiments of the present disclosure are shown. As those skilled in the art would realize, the described embodiments may be modified in various different ways, all without departing from the spirit or scope of the present disclosure.

Items described in the singular herein may be provided in plural, as can be seen, for example, in the drawings. Thus, the description of a single item that is provided in plural should be understood to be applicable to the remaining plurality of items unless context indicates otherwise.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first”) in a particular claim may be described elsewhere with a different ordinal number (e.g., “second”) in the specification or another claim. A control unit and various other units or analyzers described herein, such as, for example Control unit 700, analysis unit 710, supply amount control unit 730, correction unit 740, calculation unit 720, first calculation unit 722, second calculation unit 724, wastewater analysis unit 110. component analysis unit 112, flow measurement unit 114, raw water analysis unit 102, and first analyzer, second analyzer, and third analyzer, may include a computer (or several interconnected computers) and may include, for example, one or more processors configured by software, such as a CPU (Central Processing Unit), GPU (graphics processor), controller, etc., forming various functional modules of the computer. The computer may be a general purpose computer or may be dedicated hardware or firmware. A computer may be configured from several interconnected computers. Each functional module (or unit) described herein may comprise a separate computer, or some or all of the functional module (or unit) may be comprised of and share the hardware of the same computer. Connections and interactions between the units described herein may be hardwired and/or in the form of data (e.g., as data stored in and retrieved from memory of the computer, such as a register, buffer, cache, storage drive, etc., such as part of an application programming interface (API)). The functional modules (or units) of the control unit may each correspond to a separate segment or segments of software (e.g., a subroutine) which configure the computer of the control unit or other units or analyzers, and/or may correspond to segment(s) of software that also correspond to one or more other functional modules (or units) described herein (e.g., the functional modules (or units) may share certain segment(s) of software or be embodied by the same segment(s) of software). As is understood, “software” refers to prescribed rules to operate a computer, such as code or script.

The drawings and description are to be regarded as illustrative in nature and not restrictive. Like reference numerals designate like elements throughout the specification.

In addition, size and thickness of each constituent element in the drawings are arbitrarily illustrated for better understanding and ease of description, the following embodiments are not limited thereto. In the drawings, sizes of components may be exaggerated for clarity or ease of description.

Unless explicitly described to the contrary, the word “comprise”, and variations such as “comprises” or “comprising”, will be understood to imply the inclusion of stated elements but not the exclusion of any other elements.

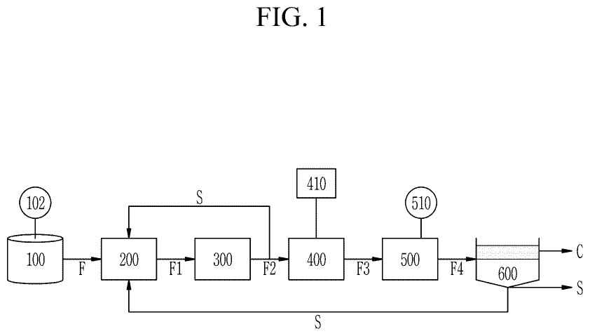

FIG. 1 is a drawing depicting a conventional wastewater treatment system.

Referring to FIG. 1, a conventional wastewater treatment system may include an organic water-collection tank 100 storing raw water F, a first denitrification tank 200, a nitrification tank 300, a second denitrification tank 400, a re-aeration tank 500, and a sedimentation tank 600.

The first denitrification tank 200 may also be referred to as a pre-denitrification tank, and may convert the raw water F into a primary treated water F1 by reducing nitrate nitrogen (NO₃—N) contained in the raw water F into nitrogen gas.

The nitrification tank 300 may convert the primary treated water F1 into a secondary treated water F2 by oxidizing ammonia nitrogen (NH₃—N) in the primary treated water F1.

The second denitrification tank 400 may also be referred to as a post- denitrification tank. An organic carbon source may be supplied to the second denitrification tank 400 to remove nitrate nitrogen (NO₃—N) from the secondary treated water F2. The second denitrification tank 400 may convert the secondary treated water F2 into a tertiary treated water F3 from which nitrate nitrogen (NO₃—N) is removed.

In the re-aeration tank 500, residual ammonia nitrogen (NH₃—N) in the tertiary treated water F3 may be oxidized into nitrate nitrogen (NO₃—N), and may be converted into a quaternary treated water F4.

The sedimentation tank 600 may separate the introduced quaternary treated water F4 into sludge S and supernatant C.

In a supply amount adjustment of the organic carbon source in the conventional method, a NO₃ concentration in the re-aeration tank 500 is measure, and according to the measured NO₃ concentration, the amount of the organic carbon source supplied to the second denitrification tank 400 is adjusted.

When a small amount of the organic carbon source is input, the NO₃ concentration of the supernatant C that is separated and discharged may increase. To the contrary, when the organic carbon source is excessively input, the NO₃ concentration of the supernatant C may decrease, and the total organic carbon (TOC) may increase.

As such, conventionally, a feed-back method was utilized, in which the adjustment of the input amount of the organic carbon source is controlled according to the NO₃ concentration in the re-aeration tank 500 after the second denitrification tank 400. However, during the course of controlling by the above- described feed-back method, manual operations in more than a certain number of times depending on various variables are performed.

In addition, in the conventional method, a raw water analysis unit 102 installed in the organic water-collection tank 100 was used to measure a NH₃ concentration in the organic water-collection tank 100. The NH₃ concentration measured by the raw water analysis unit 102 is used to adjust the amount of the organic carbon source to be supplied from the second denitrification tank 400. For example, in the conventional wastewater processing apparatus, to analyze the NH₃ in the raw water, an analysis unit is disposed in an organic water-collection tank in which the raw water is stored to monitor the raw water, and the wastewater treatment process was performed depending on the monitoring result.

However, there was a problem that the analysis value obtained through the above-described raw water analysis unit 102 has poor reliability.

A problem may arise due to damage and failure, preventive maintenance (PM), and the like, of component parts of the raw water analysis unit 102, and errors may occur due to other various variables. Otherwise, there was a problem that the reliability of the analysis unit is deteriorated, e.g., distribution occurs in the analysis unit data according to an unexpected situation (e.g., scale, scum, or the like).

In addition, there was also a problem that, when a problem or change of the wastewater has occurred before being supplied to the organic water-collection tank 100, the above-described change was not immediately reflected, and thus it was difficult to reflect the change of the wastewater. For example, when the raw water changes according to the change of the wastewater, it was not possible to confirm the point of change of the raw water.

When the wastewater supplied to the organic water-collection tank 100 is changed, separate manual operation was inevitable, and because it was not easy to confirm the above-described point of change, when the above-described change has occurred, it was difficult to correspond to it. For example, because there was not sufficient golden time to correspond to the above-described emergency situation, it was difficult to adjust a supply amount of the organic carbon source in an appropriate amount during the wastewater processing process.

As such, conventionally, the analysis value of the NH₃ concentration in the organic water-collection tank 100 showed poor reliability and thus was used only for monitoring, and to input the organic carbon source, the NO₃ concentration in the re-aeration tank 500 was measured.

A method of adjusting the input amount of the organic carbon source according to the NO₃ concentration measured as such may be considered as a feed-back control method. The feed-back control was inconvenient in that, as the above-mentioned unexpected variables and errors occur, the input amount of the organic carbon source needs to be adjusted manually and continuously.

Unlike this, a wastewater treatment system 10 according to the present disclosure is characterized in that information of the supplied raw water F is accurately calculated by analyzing the wastewater itself transferred to the organic water-collection tank 100 in real time, instead of using the raw water analysis unit 102.

Accordingly, when a change occurs in the supplied wastewater, the change may be immediately reflected to the information of the raw water F stored in the organic water-collection tank 100, and the point of change of the wastewater may be predicted.

In addition, the wastewater treatment system 10 according to the present disclosure is characterized by using a feed-forward control method, in which an input amount of the organic carbon source to be supplied to the second denitrification tank 400 is calculated by using the NH₃ concentration of the raw water F derived by analyzing a wastewater W, the NO₃ concentration in the first denitrification tank 200, and the NH₃ concentration value in the nitrification tank 300, and the supply amount of the organic carbon source is adjusted accordingly. Accordingly, there is no need to manually adjust the amount of the organic carbon source supplied to the second denitrification tank 400 depending on the NO₃ concentration in the nitrification tank 300.

Hereinafter, the wastewater treatment system 10 according to an embodiment of the present disclosure and a wastewater treatment method using the same will be described in detail with reference to the drawings.

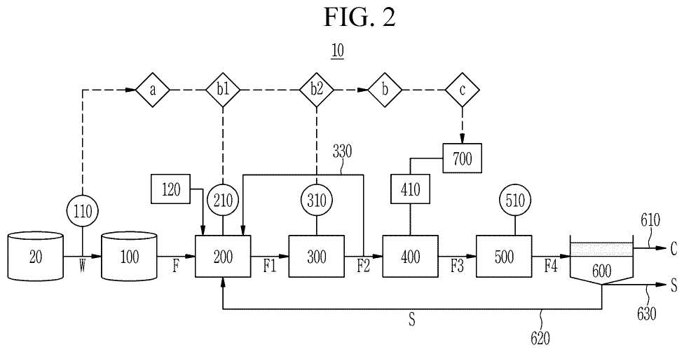

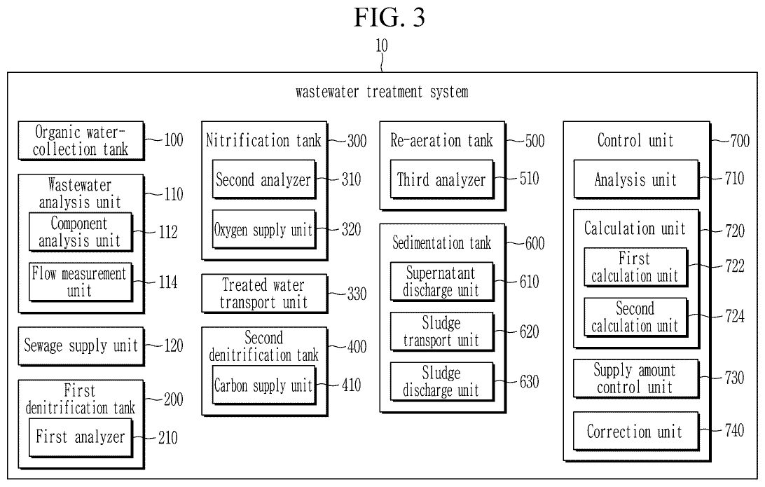

FIG. 2 is a drawing for explaining a wastewater treatment system according to an embodiment, and FIG. 3 is a drawing for explaining a configuration of a wastewater treatment system according to an embodiment.

As shown in FIG. 2 and FIG. 3, the wastewater treatment system 10 according to the present disclosure may include the organic water-collection tank 100, the first denitrification tank 200, the nitrification tank 300, the second denitrification tank 400, the re-aeration tank 500, and the sedimentation tank 600.

First, the organic water-collection tank 100 may receive the wastewater W discharged from a wastewater supply device 20 and store the received wastewater as the raw water F.

The raw water F may be introduced into the first denitrification tank 200. The raw water F introduced into the first denitrification tank 200 may be converted into the primary treated water F1 as nitrate nitrogen (NO₃—N) included in the raw water F is reduced into nitrogen gas. The first denitrification tank 200 may include a first analyzer 210 configured to analyze the NO₃ concentration in the primary treated water F1. The first analyzer 210 analyzes the primary treated water F1, and is preferably disposed on a downstream side of the first denitrification tank 200.

The wastewater treatment system 10 may further include a sewage supply unit 120 configured to supply sewage to the first denitrification tank 200.

The primary treated water F1 may be introduced into the nitrification tank 300. The primary treated water F1 introduced into the nitrification tank 300 may be converted into the secondary treated water F2 by oxidizing ammonia nitrogen (NH₃—N) in the primary treated water F1. The nitrification tank 300 may include a second analyzer 310 configured to analyze the NH₃ concentration in the secondary treated water F2. The second analyzer 310 analyzes the secondary treated water F2, and is preferably disposed on a downstream side of the nitrification tank 300.

The nitrification tank 300 may further include an oxygen supply unit 320 for promoting the nitrification reaction.

In addition, The wastewater treatment system 10 may further include an internal transport unit 330. The internal transport unit 330 configured to transport the secondary treated water F2 outflowing from the nitrification tank 300. The internal transport unit 330 may transport a portion of the secondary treated water F2 outflowing from the nitrification tank 300 back to the first denitrification tank 200. An amount of the portion of the transported secondary treated water F2 that is transported back to the first denitrification tank, may be defined as an internal transport amount.

The second denitrification tank 400 may include a carbon supply unit 410 configured to supply the organic carbon source. A carbon supply unit may be or include a tank or other apparatus that includes an organic carbon source therein that is configured such that carbon may be stored therein and supplied, e.g., via a pipe to other components, such as tanks, of the present systems and methods.

The secondary treated water F2 may be introduced into the second denitrification tank 400. The secondary treated water F2 introduced into the second denitrification tank 400 may be converted into the tertiary treated water F3 by removing residual nitrate nitrogen (NO₃—N) in the secondary treated water F2 by the organic carbon source.

The re-aeration tank 500 may receive the tertiary treated water F3. The tertiary treated water F3 introduced into the re-aeration tank 500 may be converted into the quaternary treated water F4 by removing nitrogen gas in the tertiary treated water F3, and oxidizing the residual ammonia nitrogen (NH₃—N) into nitrate nitrogen (NO₃—N). The re-aeration tank 500 may include a third analyzer 510 configured to analyze the NO₃ concentration in the quaternary treated water F4. The third analyzer 510 analyzes the quaternary treated water F4, and is preferably disposed on a downstream side of the re-aeration tank 500.

The sedimentation tank 600 may receive the quaternary treated water F4, and may separate the introduced quaternary treated water F4 into the sludge S and the supernatant C. The sludge S may be separated from the supernatant C by being sedimented in the sedimentation tank 600.

The sedimentation tank 600 may include a supernatant discharge unit 610 configured to discharge the supernatant C to the outside, a sludge transport unit 620 configured to transport a portion of the sludge S to the first denitrification tank 200, and a sludge discharge unit 630 configured to discharge the remaining sludge S after the transport to the outside. The supernatant discharge unit 610 and/or sludge discharge unit may be or include for example, a pipe or tube or other component suitable for transporting or moving supernatant or sludge, for example to the outside of the sedimentation tank 600 or outside the present systems. The sludge transport unit 620 may be or include for example, a pipe or tube or other component suitable for transporting or moving sludge to the first denitrification tank 200.

A transport amount configured to include the sludge S transported by the sludge transport unit 620 may be defined as a sedimentation transport amount.

The wastewater treatment system 10 according to the present disclosure may include a wastewater analysis unit 110 configured to analyze information of the wastewater W discharged from the wastewater supply device 20.

The wastewater analysis unit 110 may include a component analysis unit 112 configured to analyze a ratio of NH3 in the wastewater W, and a flow measurement unit 114 configured to measure a flow amount of the wastewater W.

Depending on the embodiment, the wastewater analysis unit 110 may be a POU meter that collects information from a Central Chemical Supply System (CCSS) within the FAB.

The wastewater treatment system 10 may include a control unit 700.

The control unit 700 may, by using the information of the wastewater W analyzed by the wastewater analysis unit 110, calculate the supply amount (input amount) of the organic carbon source to the second denitrification tank 400, and may control the carbon supply unit 410 such that the organic carbon source may be supplied as much as the calculated supply amount.

The control unit 700 may perform the control by calculating the amount of the organic carbon source to be supplied from the second denitrification tank 400 by using the information of the wastewater W analyzed by the wastewater analysis unit 110, such that the organic carbon source may be supplied as much as the supply amount. The equations for the supply of organic carbon sources are given in [Equation 1]-[Equation 3] below.

Specifically, the control unit 700 may include an analysis unit 710 configured to analyze the NH₃ concentration of the raw water F stored in the organic water-collection tank 100 by using the information of the wastewater W analyzed by the wastewater analysis unit 110, a calculation unit 720 configured to calculate a supply amount of the organic carbon source to be supplied to the second denitrification tank 400 by using the NH₃ concentration analyzed by the analysis unit 710, and a supply amount control unit 730 configured to adjust the carbon supply unit 410 such that the organic carbon source may be supplied as much as the calculated supply amount.

The analysis unit 710 may analyze the NH₃ concentration of the raw water F by using the ratio of NH₃ in the wastewater W, the flow amount of the wastewater W, and inflow amount information of the raw water F introduced into the organic water-collection tank 100.

Here, the ratio of NH₃ in the wastewater W, the flow amount of the wastewater W may use the value analyzed and measured by the component analysis unit 112 and the flow measurement unit 114 of the wastewater analysis unit 110.

The component analysis unit 112 may analyze components included in the wastewater W, and may analyze ratio (content %) of NH₃ for each component of the wastewater W.

For example, when the wastewater W includes components of NH₄OH, 2% NH₄OH, and SP500 (NH₄F, NH₄(HF₂)), the component analysis unit 112 can determine for example, that NH₄OH contains 29% NH₃, 2% NH₄OH contains 2% NH₃, NH₄F contains 12% NH₃, and NH₄(HF₂) contains 7% NH₃. This is a non-limiting example.

In the flow measurement unit 114, the flow amount may be measured, and depending on the embodiment, the daily usage may be measured.

The equation by which the analysis unit 710 calculates the NH₃ concentration (a) of the raw water F in the organic water-collection tank 100 by using the above-described analysis value is as follows.

$$\qquad [ Equation 1 ]$$

$${NH}_{3} concentration in each component ( kg {NH}_{3} / d ) = ratio ( ppm ) \times {NH}_{3} molecular weight \times number of {NH}_{3} / component molecular weight ) \times the daily usage .$$

$$1. {NH}_{4} OH ( a 1 ) = ( 29 \times 10000 ) \times ( 17 \times 1 / 35 ) \times the daily usage$$

$$2. 2 \% {NH}_{4} OH ( a 2 ) = ( 2 \times 10000 ) \times ( 17 \times 1 / 35 ) \times the daily usage$$

$$3. SP 500 ( {NH}_{4} F , {NH}_{4} ( {HF}_{2} ) ) ( a 3 ) = ( ( 12 \times 1000 ) \times ( 17 \times 1 / 37 ) + ( 7 \times 10000 ) \times ( 17 \times 1 / 57 ) ) \times the daily usage$$

$$4. the {NH}_{3} concentration ( a ) of the raw water F = total amount of {NH}_{3} ( kg {NH}_{3} / d ) / \text{} organic \text{} water \text{} - \text{} collection tank inflow amount ( {m}^{3} / d ) .$$

In this example, the total amount of NH₃ may mean a1+a2+a2, and organic water-collection tank inflow amount may mean the amount of entire solution introduced into the organic water-collection tank 100.

The NH₃ concentration (a) of the raw water F may be a value automatically analyzed by the wastewater analysis unit 110. This is the information corresponding to “a” shown in FIG. 2, which even though it is shown from wastewater W includes information regarding raw water F.

The calculation unit 720 may include a first calculation unit 722 and a second calculation unit 724.

The first calculation unit 722 may calculate the NO₃ concentration in the secondary treated water F2 outflowing from the nitrification tank 300 by using the NH₃ concentration (a) of the raw water F analyzed by the analysis unit 710.

The second calculation unit 724 may calculate the supply amount of the organic carbon source to the second denitrification tank 400 by using the NO₃ concentration analyzed by the first calculation unit 722.

Here, as shown in FIG. 2, the first calculation unit 722 may calculate the NO₃ concentration (b) in the secondary treated water F2 the NH₃ concentration (a) of the raw water F analyzed by the analysis unit 710, the NO₃ concentration b1 in the primary treated water F1 analyzed by the first analyzer 210, by using the NH₃ concentration b2 value in the secondary treated water F2 analyzed by the second analyzer 310.

The equation by which the first calculation unit 722 calculates the NO₃ concentration (b) of the secondary treated water F2 outflowing from the nitrification tank 300 is as follows.

$$[ Equation 2 ]$$

$$N {O}_{3} concentration ( b ) of the secondary treated water F 2 = {NO}_{3} concentration b 1 of primary treated water F 1 + {NH}_{3} concentration converted from {NO}_{3} in nitrification tank 300 = {NO}_{3} concentation b 1 of primary treated water F 1 + ( ( {NH}_{3} concentration ( a ) of raw water F \times raw water F inflow amount + ( internal transport amount \times {NH}_{3} concentration b 2 of secondary treated water F 2 ) + ( sedimentation transport amount \times {NH}_{3} concentration of sedimentation \text{} tank ) + ( sewage \text{} supply amount \times {NH}_{3} concentration of sewage ) ) \text{} / \text{} ( raw water F inflow amount + i nternal transport amount \text{} + edimentation transport amount + sewage supply amount ) ) \text{} - {NH}_{3} concentration b 2 of secondary \text{} treated \text{} \text{} water \text{} F \text{} 2$$

Here, the NH₃ concentration of the sedimentation tank 600 may be replaced with the NH₃ concentration of the nitrification tank 300. Depending on the embodiment, a sedimentation tank concentration measurement system that can measure the NH₃ concentration of the sedimentation tank 600 may be further included.

In addition, the NH₃ concentration of the supplied sewage may be replaced with the design concentration. Depending on the embodiment, a sewage concentration measurement system that can measure the NH₃ concentration of the sewage may be further included in the sewage supply unit 120.

The internal transport amount may mean an amount of a portion of the secondary treated water F2 transported along the internal transport unit 330, and the sedimentation transport amount may mean an amount including the sludge S transported along the sludge transport unit 620. The sewage supply amount may mean an amount supplied from the sewage supply unit 120.

Although not shown, flow meters (not shown) that can measure the supplied and transported amounts may be further included. However, it is not limited to measurement using a flow meter, and of course, it can be measured in various ways.

The NH₃ concentration (a) of the raw water F used in [Equation 2] may be applied in consideration of the time sufficient for the wastewater W to reach the organic water-collection tank 100 from the wastewater analysis unit 110. The above-described time may be applied as any time between 1 to 24 hours.

For example, there is a time gap between the time point analyzed by the wastewater analysis unit 110 and the time point at which the analyzed wastewater W moves to the organic water-collection tank 100 and is stored therein as the raw water F.

For example, if the above-described time gap is 4 hours, the NH₃ concentration (a) of the raw water F may be a value calculated by using a value analyzed by using the information analyzed by the wastewater analysis unit 110 4 hours ago.

The second calculation unit 724 may calculate the supply amount (c) of the organic carbon source by using the NO₃ concentration (b) value in the secondary treated water F2 calculated in [Equation 2].

The equation by which the second calculation unit 724 calculates the supply amount (c) of the organic carbon source to be supplied to the second denitrification tank 400 is as follows.

$$[ Equation 3 ]$$

$$Supply amount ( c ) of organic carbon source = K 1 \times {NO}_{3} concentration ( b ) of secondary treated water F 2 + K 2$$

K1 and K2 may be constants, and can be changed, reflected, and used according to field conditions and equipment.

The wastewater treatment system 10 according to the present disclosure may be included in a method in which the amount (c) of the organic carbon source to be supplied to the second denitrification tank 400, is calculated by using the NH₃ concentration (a) of the raw water F derived from the wastewater W, the NO₃ concentration b1 in the first denitrification tank 200, and the NH₃ concentration b2 value in the nitrification tank 300, and the supply amount of the organic carbon source is accordingly adjusted. This may be regarded as a feed-forward control method.

Additionally, in the feed-forward control method, to accurately calculate the supply amount of the organic carbon source, the sewage supplied to the first denitrification tank 200, the internal transport amount transported from the nitrification tank 300 to the first denitrification tank 200, a transport amount value of the sludge S transported from the sedimentation tank 600 may be additionally used (see Equation 2).

In the case of the conventional method, which is a feed-back control method in which the amount of the organic carbon source is adjusted according to the NO₃ concentration in the quaternary treated water F4 outflowing from the re-aeration tank 500, there was inconvenience in that the input amount of the organic carbon source needs to be manually manipulated according to various variables occurring on the upstream side. On the other hand, the case according to the present disclosure is significant compared to the conventional art, in that the supply amount of the organic carbon source is control in consideration of all various variables occurring on the upstream side, and that automatic control without a manual operation is enabled.

In addition, according to the conventional method, because it uses the raw water analysis unit 102 configured to measure the NH₃ concentration in the organic water-collection tank 100, there was a problem that reliability is deteriorated during the above-described measurement process. On the other hand, in the wastewater treatment system 10 according to the present disclosure, reliability is improved in that the concentration of the raw water F is measured from the information of the wastewater W without using the above-described raw water analysis unit 102, but by using the wastewater analysis unit 110 analyzing the wastewater W transferred to the organic water-collection tank 100. For example, when a change occurs in the wastewater W before being transferred to the organic water-collection tank 100, it is meaningful that the change of the wastewater W may be immediately reflected to the raw water F, such that the input amount of the organic carbon source may be automatically adjusted.

Additionally, the wastewater treatment system 10 according to the present disclosure may further include a correction unit 740 configured to compensate the supply amount of the organic carbon source calculated by the calculation unit 720.

When the NO₃ concentration in the quaternary treated water F4 outflowing from the re-aeration tank 500 is out of a predetermined concentration range, the correction unit 740 may serve to compensate the supply amount of the organic carbon source calculated by the calculation unit 720. Through this, the supply amount of the organic carbon source may be accurately supplied as a sufficient amount to control nitrogen concentration to a desired concentration.

A process of compensating the supply amount of the organic carbon source by the correction unit 740 may be considered to correspond to the feed-back control method used in the conventional art.

However, in the wastewater treatment system 10 according to the present disclosure is different in that the feed-forward control method may be mainly used in the process of controlling the organic carbon source, and the feed-back control method is auxiliary used.

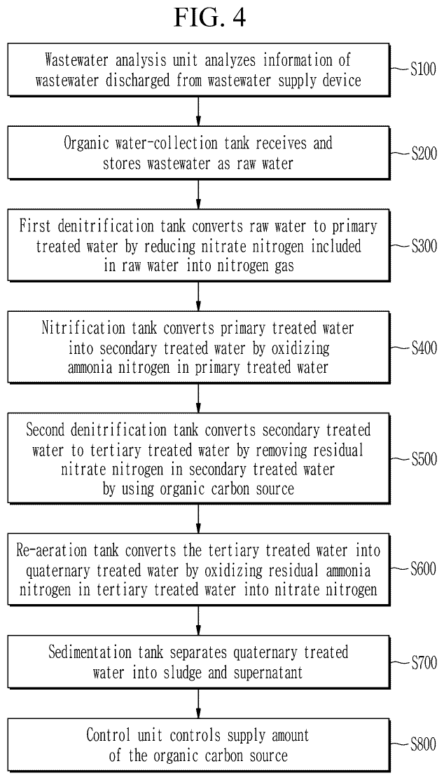

FIG. 4 to FIG. 8 are flowcharts for explaining a wastewater treatment method according to an embodiment.

A wastewater treatment method according to the present disclosure may correspond to a wastewater treatment method using the wastewater treatment system 10 described above.

As shown in FIG. 4, the wastewater treatment method may include a step S100 of analyzing, by the wastewater analysis unit 110, the information of the wastewater W discharged from the wastewater supply device 20, a step S200 of receiving, by the organic water-collection tank 100, the wastewater W and storing the received wastewater as the raw water F, a step S300 of receiving, by the first denitrification tank 200, the raw water F and converting the raw water into the primary treated water F1 by reducing nitrate nitrogen (NO₃—N) contained in the raw water F into nitrogen gas, a step S400 of receiving, by the nitrification tank 300, the primary treated water F1 and converting the primary treated water into the secondary treated water F2 by oxidizing ammonia nitrogen (NH₃—N) in the primary treated water F1, a step S500 of receiving, by the second denitrification tank 400, the secondary treated water F2 and converting the received secondary treated water F2 into the tertiary treated water F3 by removing the residual nitrate nitrogen (NO₃—N) in the secondary treated water F2 by using the organic carbon source, a step S600 of receiving, by the re-aeration tank 500, the tertiary treated water F3 and converting the tertiary treated water into the quaternary treated water F4 by oxidizing the residual ammonia nitrogen (NH₃—N) in the tertiary treated water F3 into nitrate nitrogen (NO₃—N), a step S700 of receiving, by the sedimentation tank 600, the quaternary treated water F4 and separating the quaternary treated water F4 into the sludge S and the supernatant C, and a step S800 of controlling, by the control unit 700, the supply amount of the organic carbon source such that the organic carbon source may be supplied to the second denitrification tank 400 as much as a sufficient amount to control nitrogen concentration. Steps on FIG. 4 may not necessarily occur in the depicted order. For example, Step S800 of the control unit 700 supplying an amount of the organic carbon source to the second denitrification tank 400, may not occur after the sedimentation tank separations quaternary treated water into sludge and supernatant.

Example systems and methods may further include a process of or apparatus for transporting, by the internal transport unit 330, the secondary treated water F2 discharged from the nitrification tank 300 to the first denitrification tank 200, and/or a process of or apparatus for supplying, by the sewage supply unit 120, sewage to the first denitrification tank 200 may be further included. The internal transport unit 330 or internal transport may be or include for example, a pipe or tube or other component suitable for transporting the secondary treated water F2 discharged from the nitrification tank 300 to the first denitrification tank 200. The sewage supply unit 120 may be or include for example, a pipe or tube or other component suitable for transporting or moving sewage to the first denitrification tank 200.

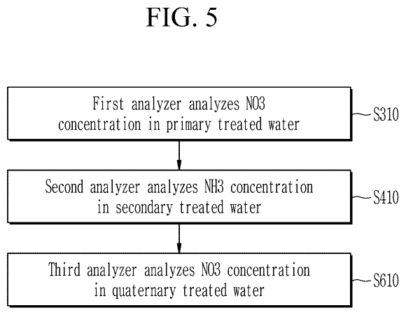

Referring to FIG. 5, a step S310 of analyzing, by the first analyzer 210, the NO₃ concentration in the primary treated water F1, a step S410 of analyzing, by the second analyzer 310, the NH₃ concentration in the secondary treated water F2, and a step S610 of analyzing, by the third analyzer 510, the NO₃ concentration in the quaternary treated water F4 may be further included.

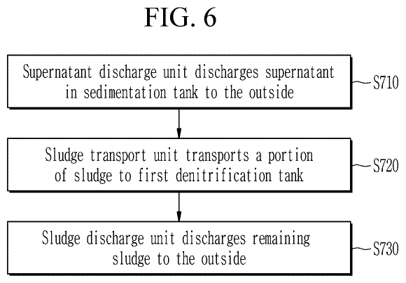

Referring to FIG. 6, in the sedimentation tank 600, a step S710 of discharging, by the supernatant discharge unit 610, the supernatant C in the sedimentation tank 600 to the outside, a step S720 of transporting, by the sludge transport unit 620, a portion of the sludge S to the first denitrification tank 200, and a step S730 of discharging, by the sludge discharge unit 630, the remaining sludge S to the outside may be further included.

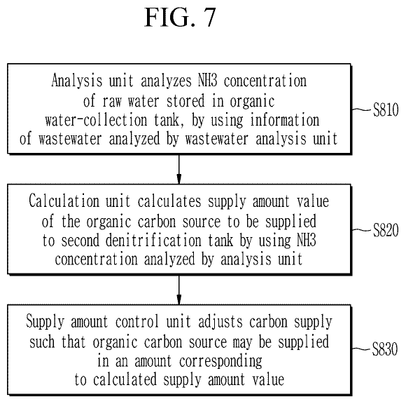

Referring to FIG. 7, the step S800 controlled by the control unit 700 may include a step S810 of analyzing, by the analysis unit 710, the NH₃ concentration of the raw water F stored in the organic water-collection tank 100, by using the information of the wastewater W analyzed by the wastewater analysis unit 110, a step S820 of calculating, by the calculation unit 720, the supply amount of the organic carbon source to be supplied to the second denitrification tank 400, by using the NH₃ concentration of the raw water F analyzed by the analysis unit 710 (Refer to [Equation 2], [Equation 3]), and a step S830 of adjusting, by the supply amount control unit 730, the carbon supply unit 410 such that the organic carbon source may be supplied as much as the calculated supply amount.

The step S810 of analyzing by the analysis unit 710 may analyze the NH₃ concentration of the raw water F by using the ratio of NH₃ in the wastewater W analyzed by the wastewater analysis unit 110, the flow amount information of the wastewater W, and the organic water-collection tank inflow amount information introduced into the organic water-collection tank 100.

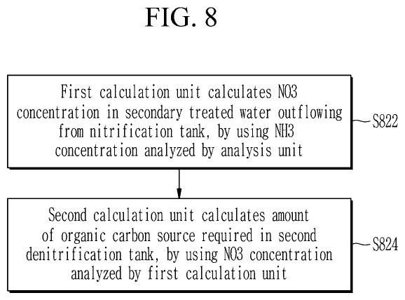

Referring to FIG. 8, the step S820 calculated by the calculation unit 720 may include a step S822 of calculating, by the first calculation unit 722, the NO₃ concentration in the secondary treated water F2 outflowing from the nitrification tank 300, by using the NH₃ concentration of the raw water F analyzed by the analysis unit 710 (Refer to [Equation 2]), and a step S824 of calculating, by the second calculation unit 724, an amount of the organic carbon source sufficient in the second denitrification tank 400 to control nitrogen concentration, by using the NO₃ concentration analyzed by the first calculation unit 722 (Refer to [Equation 3]).

Additionally, at the step S800 controlled by the control unit 700, the correction unit 740 may compensate the supply amount of the organic carbon source calculated by the calculation unit 720 when the NO₃ concentration in the quaternary treated water F4 outflowing from the re-aeration tank 500 is out of a predetermined concentration range.

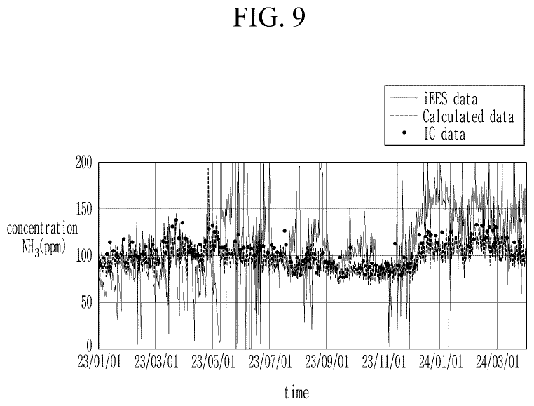

FIG. 9 to FIG. 13B are drawings for explaining an effect of a wastewater treatment system according to an embodiment.

FIG. 9 to FIG. 12 are graphs showing data from actual experiments.

FIG. 9 is a drawing for explaining the reliability of the NH₃ concentration of the raw water F analyzed by using the value analyzed by the wastewater analysis unit 110 of the wastewater treatment system 10 according to the present disclosure.

FIG. 9 illustrates graphs of data for the NH₃ concentration of the raw water F analyzed by the wastewater treatment system 10, and as the conventional art, the NH₃ concentration of the raw water F analyzed by using the raw water analysis unit 102 installed in the organic water-collection tank 100.

iEES data may correspond to the NH₃ concentration value of the raw water F according to the conventional art, and the calculated data may correspond to the NH₃ concentration value of the raw water F according to the present disclosure.

The iEES data represent the result obtained by analysis by the raw water analysis unit 102 installed in the organic water-collection tank 100, and it may be confirmed that the reliability is deteriorated due to various external factors. The calculated data represent the result obtained by analyzing the actual wastewater W, and it may be confirmed that it has high reliability because the trend coincide with water analysis data obtained through ion chromatography with high reliability (IC data). The IC data has high reliability but has a disadvantage of being expensive and time-consuming to analyze.

According to the present disclosure, the conventional installation cost and cost and time for the maintenance of the raw water analysis unit 102 may be reduced, and the reliability of the NH₃ concentration of the raw water F may be raised without performing water analysis to compare the results.

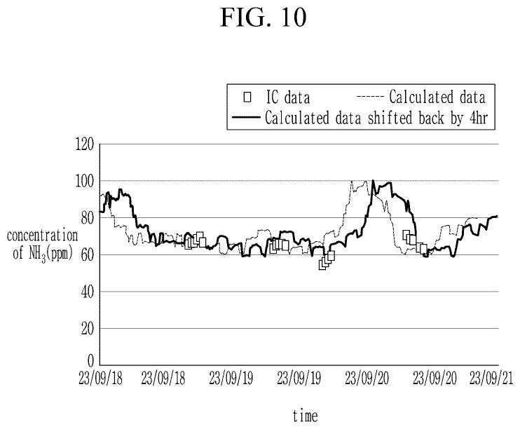

FIG. 10 is a graph showing that, when the NH₃ concentration of the raw water F is analyzed according to the present disclosure, when a change has occurred in the wastewater W before being transferred to the organic water-collection tank 100, the raw water F the NH₃ concentration analysis may be performed by reflecting the change of the wastewater W.

Conventionally, when a problem or change has occurred in the wastewater before being supplied to the organic water-collection tank 100, the change was not immediately reflected, and it was difficult to reflect the change of the wastewater W. When the raw water F changes according to the change of the wastewater W, the concentration change point of the raw water F could not be confirmed.

In the wastewater treatment system 10 according to the present disclosure, the information of the supplied raw water F is accurately measured by analyzing the wastewater W itself in real time, and when a change has occurred in the supplied wastewater W, the change is immediately reflected to the information of the raw water F stored in the organic water-collection tank 100, thereby being capable of predicting the change point of the wastewater W concentration.

Referring to FIG. 10, IC data may correspond to the NH₃ concentration value of the raw water F through the conventional ion chromatography water analysis, and the calculated data may correspond to the NH₃ concentration value of the raw water F according to the present disclosure. The “Calculated data shifted back by 4 hr” corresponds to the calculated data value shifted back by 4 hours, and because the corresponding data coincide with the IC data, it may be confirmed that the time to reach the organic water-collection tank 100 from the wastewater analysis unit 110 is approximately 4 hours.

According to the conventional art, although it is not possible to predict that the wastewater W is already changed, it may be confirmed that, by referring to the IC data value according to the present disclosure, the concentration change point of the wastewater W may be predicted before 4 hours at minimum, and by reflecting this, the NH₃ concentration of the raw water F may be analyzed.

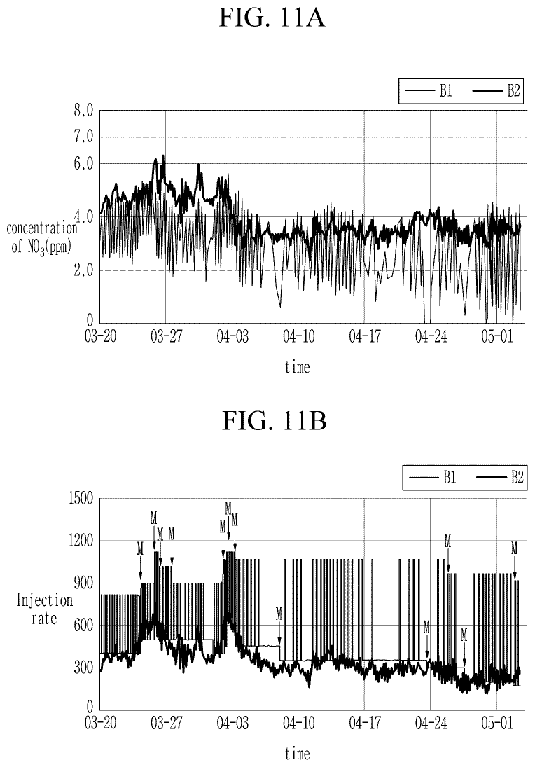

FIGS. 11A and 11B are graphs showing the effect that, according to a wastewater treatment according to the present disclosure, manual operations may be significantly decreased compared to the conventional art, and as the manual operations are decreased, the quality of the supernatant C due to the wastewater treatment may become stable.

FIG. 11A is a graph comparing the NO₃ concentration in the supernatant C.

In FIG. 11A, B1 represents the NO₃ concentration in the supernatant C according to the conventional wastewater treatment method (i.e., feed-back), and B2 represents the NO₃ concentration in the supernatant C according to a wastewater treatment method (i.e., feed-forward) according to the present disclosure.

Referring to B1, it may be confirmed that the NOs concentration in the supernatant C deviates from a preset criteria range (2 to 7 ppm). On the other hand, referring to B2, it may be confirmed that the NO₃ concentration in the supernatant C has a stable quality without deviating from the preset range.

FIG. 11B is a graph showing a process of controlling the input amount of the organic carbon source.

In FIG. 11B, B1 may be a process of controlling the input amount of the organic carbon source according to the conventional wastewater treatment method (i.e., feed-back), and the indicated M may mean a point where the manual operation is performed. B2 may be a process of controlling the input amount of the organic carbon source according to a wastewater treatment method (i.e., feed-forward) according to the present disclosure. In B1, manual operations M are performed 12 times on the graph. On the other hand, in B2, it may be confirmed that the automatic control is possible without a manual operation.

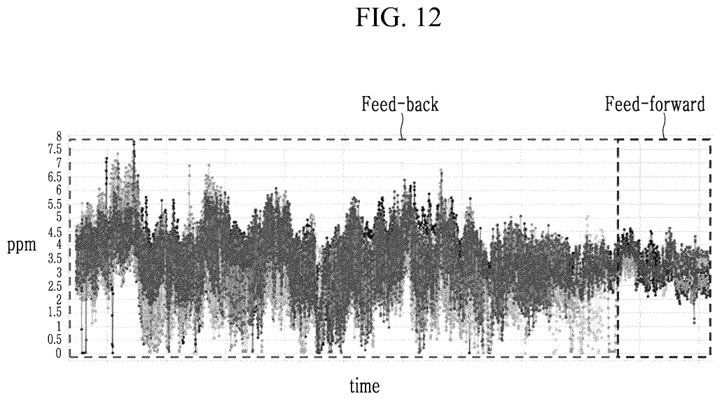

FIG. 12 is a graph showing that, in wastewater treatment systems according to the present disclosure, the input amount of the organic carbon source is decreased compared to the conventional art.

The vertical axis in FIG. 12 means the NO₃ concentration (ppm) of the supernatant C, and through the graph of FIG. 12, the distribution of the supernatant C the NO₃ concentration is significantly decreased in the feed-forward method of the wastewater treatment system 10 according to the present disclosure, compared to the conventional wastewater treatment method (i.e., feed-back).

The decrease of the input amount of the organic carbon source may be due to the decrease of the above-described distribution.

According to actual experiments, it was possible to confirm that, compared to the case of the conventional wastewater treatment method (i.e., feed-back), in which the organic carbon source was input as much as 516 ppm (experimental condition: NH₃ concentration of raw water F being 79.7 ppm, NO₃ concentration of supernatant C being 3.0 ppm), in a wastewater treatment method (i.e., feed-forward) according to the present disclosure, the organic carbon source was input as much as 354 ppm (experimental condition: NH₃ concentration of raw water F being 79.9 ppm, NO₃ concentration of supernatant C being 3.1 ppm). For example, it was possible to confirm that, in the case of the wastewater treatment method (i.e., feed-forward) according to the present disclosure, compared to the conventional art, the input amount of the organic carbon source is decreased by 30% or more.

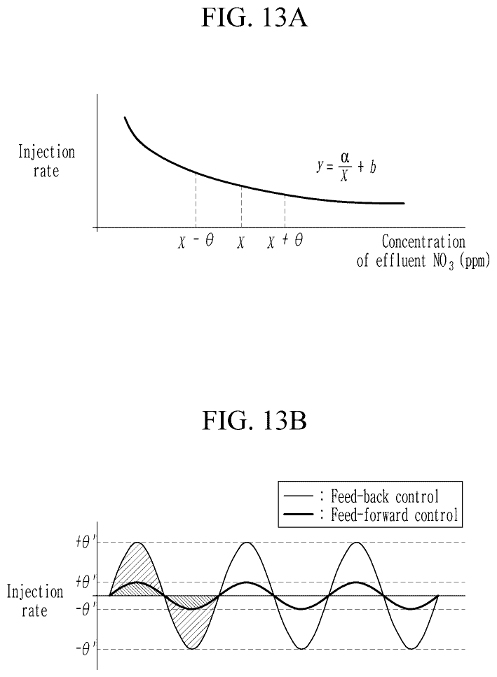

FIGS. 13A and 13B are graphs showing a co-relationship between the input rate of the organic carbon source and the concentration of the treated water quality. FIGS. 13A and 13B show that the cause of the decrease of the input amount of the organic carbon source is the decrease of the distribution.

Referring to FIG. 13A, when the input amount of water treatment agent such as the organic carbon source is y, and the concentration of the target treated water quality is x, it can be defined by the equation of y=a/x+b. Here, a and b correspond to constant values.

When it is assumed that it moves from an average target treated water quality x at a treated water quality distribution Θ, an average chemical input amount y may be calculated through the equation of y=ax/(x²−Θ²)+b. The average chemical input amount y decreases as the distribution Θ decreases.

From FIG. 12 and FIG. 13B, it may be confirmed that the chemical input amount y is smaller as the distribution Θ of the treated water quality is smaller, and when the wastewater is treated by a feed-forward method according to the present disclosure, the chemical input amount, for example, the input amount of the organic carbon source, may be decreased.

As have been described above, according to the wastewater treatment system 10 according to the present disclosure and a wastewater treatment method using the same, by controlling the input amount of the organic carbon source in a feed-forward method using the same while reflecting the change of the wastewater in real time, the wastewater treatment process including controlling the input amount of the organic carbon source may be automated.

In addition, the quality of the supernatant, which is the wastewater treatment result, may be stabilized, and the input amount of the organic carbon source used in the wastewater treatment may be decreased.

While this disclosure has been described in connection with what is presently considered to be practical embodiments, it is to be understood that the invention is not limited to the disclosed embodiments, but, on the contrary, covers various modifications and equivalent arrangements included within the spirit and scope of the appended claims.

What is claimed is:

1. A wastewater treatment system, comprising:
an organic water-collection tank configured to receive wastewater discharged from a wastewater supply device and to store the received wastewater as raw water;
a first denitrification tank configured to receive the raw water from the organic water-collection tank and to convert the raw water into primary treated water by reducing nitrate nitrogen contained in the raw water into nitrogen gas;
a nitrification tank configured to receive the primary treated water from the first denitrification tank and to convert the primary treated water into secondary treated water by oxidizing ammonia nitrogen in the primary treated water;
a carbon supply unit;
a second denitrification tank configured to receive the secondary treated water from the nitrification tank, and to receive an organic carbon source from the carbon supply unit, to remove residual nitrate nitrogen from the secondary treated water to convert the secondary treated water into tertiary treated water;
a re-aeration tank configured to receive the tertiary treated water from the second denitrification tank and to convert the tertiary treated water into quaternary treated water by removing nitrogen gas from the tertiary treated water and oxidizing residual ammonia nitrogen in the tertiary treated water into nitrate nitrogen;
a sedimentation tank configured to receive quaternary treated water from the re-aeration tank and to separate the quaternary treated water into sludge and supernatant;
a wastewater analysis unit configured to analyze information from the wastewater discharged from the wastewater supply device; and
a control unit configured to calculate a supply amount of the organic carbon source to be supplied from the carbon supply unit to the second denitrification tank, using information from the wastewater analyzed by the wastewater analysis unit, and configured to control supply of the supply amount of the organic carbon source from the carbon supply unit to the second denitrification tank.

2. The wastewater treatment system of claim 1, wherein the sedimentation tank comprises:
a supernatant discharge unit configured to discharge the supernatant to outside the wastewater treatment system;
a sludge transport unit configured to transport a first portion of the sludge to the first denitrification tank; and
a sludge discharge unit configured to discharge a second portion of the sludge to outside the wastewater treatment system.

3. The wastewater treatment system of claim 1, further comprising an oxygen supply unit for supplying oxygen to the nitrification tank to promote a nitrification reaction within the nitrification tank.

4. The wastewater treatment system of claim 1, further comprising a sewage supply unit configured to supply sewage to the first denitrification tank.

5. The wastewater treatment system of claim 1, further comprising an internal transport unit configured to transport a portion of the secondary treated water discharged from the nitrification tank to the first denitrification tank.

6. A wastewater treatment system, comprising:
a wastewater analysis unit configured to analyze information from wastewater discharged from a wastewater supply device;
an organic water-collection tank configured to receive the wastewater discharged from the wastewater supply device and to store the received wastewater as raw water;
a first denitrification tank configured to receive the raw water from the organic water-collection tank, and to convert the raw water into primary treated water by reducing nitrate nitrogen contained in the raw water into nitrogen gas;
a first analyzer configured to analyze a first NO₃ concentration in the primary treated water;
a nitrification tank configured to receive the primary treated water from the first denitrification tank, and to convert the primary treated water into secondary treated water by oxidizing ammonia nitrogen in the primary treated water;
a second analyzer configured to analyze a second NH₃ concentration in the secondary treated water;
a carbon supply unit;
a second denitrification tank configured to receive the secondary treated water from the nitrification tank, and to receive an organic carbon source from the carbon supply unit, to remove residual nitrate nitrogen from the secondary treated water to convert the secondary treated water into tertiary treated water;
a re-aeration tank configured to receive the tertiary treated water from the second denitrification tank, and to convert the tertiary treated water into quaternary treated water by removing nitrogen gas from the tertiary treated water, and oxidizing residual ammonia nitrogen in the tertiary treated water into nitrate nitrogen,
a third analyzer configured to analyze a third NO3 concentration in the quaternary treated water;
a sedimentation tank configured to receive the quaternary treated water from the re-aeration tank to separate the quaternary treated water into sludge and supernatant; and
a control unit configured to calculate a supply amount of the organic carbon source to be supplied from the carbon supply unit to the second denitrification tank, using information from wastewater analyzed by the wastewater analysis unit, and configured to control a supply amount of the organic carbon source from the carbon supply unit to the second denitrification tank.

7. The wastewater treatment system of claim 6, wherein the control unit comprises:
an analysis unit configured to analyze a first NH₃ concentration of the raw water stored in the organic water-collection tank by using the information from the wastewater analyzed by the wastewater analysis unit;
a calculation unit configured to, by using the first NH₃ concentration of the raw water analyzed by the analysis unit, calculate a calculated supply amount of the organic carbon source to be supplied to the second denitrification tank; and
a supply amount control unit configured to adjust carbon supply such that the organic carbon source is supplied to the second denitrification tank in an amount corresponding to the calculated supply amount.

8. The wastewater treatment system of claim 7, wherein the wastewater analysis unit comprises:
a component analysis unit configured to analyze a ratio of NH₃ in the wastewater; and
a flow measurement unit configured to measure a flow amount of the wastewater.

9. The wastewater treatment system of claim 8, wherein the analysis unit analyzes the first NH₃ concentration of the raw water, by using the ratio of NH₃ in the wastewater, the flow amount of the wastewater, and inflow amount information from the raw water introduced into the organic water-collection tank.

10. The wastewater treatment system of claim 8, wherein the calculation unit is configured to:
calculate a second NO₃ concentration in the secondary treated water outflowing from the nitrification tank, by using the first NH₃ concentration of the raw water analyzed by the analysis unit; and
calculate the supply amount of the organic carbon source to be supplied from the carbon supply unit to the second denitrification tank, by using the third NO₃ concentration.

11. The wastewater treatment system of claim 6, wherein the control unit further comprises a correction unit configured to compensate a supply amount of the organic carbon source calculated by a calculation unit, when the third NO₃ concentration in the quaternary treated water outflowing from the re-aeration tank is out of a predetermined concentration range.

12. A wastewater treatment method, comprising:
analyzing information from wastewater discharged from a wastewater supply device;
receiving, by an organic water-collection tank, the wastewater and storing the wastewater as raw water;
receiving, by a first denitrification tank, the raw water from the organic water-collection tank and converting the raw water into a primary treated water by reducing nitrate nitrogen contained in the raw water into nitrogen gas;
receiving, by a nitrification tank, the primary treated water from the first denitrification tank, and converting the primary treated water into a secondary treated water by oxidizing ammonia nitrogen in the primary treated water;
receiving, by a second denitrification tank, the secondary treated water from the nitrification tank, and converting the secondary treated water into a tertiary treated water by removing residual nitrate nitrogen from the secondary treated water by using an organic carbon source;
receiving, by a re-aeration tank, the tertiary treated water from the second denitrification tank, removing nitrogen gas in the tertiary treated water, and converting the tertiary treated water into a quaternary treated water by oxidizing residual ammonia nitrogen into nitrate nitrogen;
receiving, by a sedimentation tank, the quaternary treated water from the re-aeration tank and separating the quaternary treated water into sludge and supernatant; and
controlling a supply amount of the organic carbon source, to supply the organic carbon source to the second denitrification tank.

13. The wastewater treatment method of claim 12, wherein: the controlling comprises:
analyzing a first NH₃ concentration of the raw water stored in the organic water-collection tank by using information from the analyzed wastewater;
calculating a calculated supply amount of the organic carbon source to be supplied to the second denitrification tank, by using the analyzed first NH₃ concentration; and
adjusting an amount of carbon to be supplied, to supply the organic carbon source to the second denitrification tank in an amount corresponding to the calculated supply amount.

14. The wastewater treatment method of claim 13, wherein, the controlling, includes correcting the calculated supply amount, when a third NO₃ concentration in the quaternary treated water outflowing from the re-aeration tank is out of a predetermined concentration range.

15. The wastewater treatment method of claim 13, wherein, in the analyzing, the first NH₃ concentration of the raw water is analyzed by using a ratio of NH₃ in the wastewater, flow amount information from the wastewater, and inflow amount information from the raw water introduced into the organic water-collection tank.

16. The wastewater treatment method of claim 13, wherein the calculating comprises:
calculating a second NO₃ concentration in the secondary treated water outflowing from the nitrification tank, by using the first NH₃ concentration; and
calculating a calculated amount of the organic carbon source suitable for the second denitrification tank, by using the second NO₃ concentration.

17. The wastewater treatment method of claim 12, further comprising:
discharging the supernatant in the sedimentation tank to outside the sedimentation tank;
transporting a first portion of the sludge to the first denitrification tank; and
discharging a second portion of the sludge to outside the sedimentation tank.

18. The wastewater treatment method of claim 12, further comprising transporting a portion of the secondary treated water discharged from the nitrification tank to the first denitrification tank.

19. The wastewater treatment method of claim 12, further comprising supplying sewage to the first denitrification tank.

20. The wastewater treatment method of claim 12, further comprising:
analyzing a first NO₃ concentration in the primary treated water;
analyzing a second NH₃ concentration in the secondary treated water; and
analyzing a third NO₃ concentration in the quaternary treated water.
